(19) United States
(12) Patent Application Publication
(10) Pub. No.: US 2022/0395360 A1
(43) Pub. Date: Dec. 15, 2022

(54) Teeth Cleaning Apparatus and Method Thereof

(71) Applicant: Shiang Yueng Feng, Colleyville, TX (US)

(72) Inventor: Shiang Yueng Feng, Colleyville, TX (US)

(21) Appl. No.: 17/875,110

(22) Filed: Jul. 27, 2022

Related U.S. Application Data
(63) Continuation-in-part of application No. 17/219,843, filed on Mar. 31, 2021.

(51) Int. Cl. A61C 17/22; A61C 17/20

(52) U.S. Cl. CPC A61C 17/228; A61C 17/20; A61C 17/227; A61C 17/221

(57) ABSTRACT

A teeth cleaning apparatus includes a mouthpiece, a transducer, a cleaning liquid supply unit and a power control unit. The mouthpiece includes a containment wall, a hollow ingress tube connector and a vibrator holder. The vibrator holder has a vibrator holder hole and a vibrator holder body, and the transducer has a stationary part and a vibrator part, wherein an end of the stationary part of the transducer is kept in the vibrator holder, and a vibrator part of the transducer is disposed near the containment wall. The cleaning liquid supply unit includes a cleaning liquid container, at least one connecting tube, and a cleaning liquid delivery unit that delivers a cleaning liquid from the cleaning liquid container through the hole of the hollow ingress tube connector of the mouthpiece piece. The power control unit is used for supplying electricity to operate the transducer to generate cavitation bubbles at a vibration frequency to dean teeth.

### CROSS-REFERENCE TO RELATED APPLICATIONS

This application is a continuation-in-part of U.S. Ser. No. 17/219,843 filed on Mar. 31, 2021 and titled “Teeth Cleaner and System” which is expressly incorporated by reference herein in its entirety for all purposes.

### FIELD OF INVENTION

This invention relates to a teeth cleaning apparatus, especially a teeth cleaning apparatus and method that uses piezoelectric ceramic discs to generate cavitation bubbles that propagate upward and downward concurrently to reach the inner and outer surfaces of all upper teeth and lower teeth in similar distances.

### PRIOR ARTS

The principles of the teeth cleaning device described in U.S. Pat. No. 4,236,889 has been in use for more than 40 years. A patient lays on his/her back, face up with mouth open; A hygienist directs such a device around the mouth to clean each tooth's surface areas. U.S. Pat. No. 5,730,594 introduces an ultrasonic scaler to augment the effectiveness of the cleaning efforts while the process remains about the same. An ultrasonic cleaner, unrelated to teeth cleaning, was revealed in U.S. Pat. No. 2,896,648 for industrial use and today can be seen used to fast cleaning of various articles including dentures. Taiwan patent number TW I-290460 uses such ultrasonic cleaning technology in a teeth cleaning apparatus. However, the fact that no such teeth cleaning products exist in the market is an evidence that such a design has some deficiencies. For example, vibrations generated by its ultrasonic vibrating elements are meant to agitate cleaning liquid above and below its hinged cleaner channels. However, the hinged cleaner channels are in contact with the vibration absorbing soft tissues of the user's inside surfaces of lips and cheeks. At the same time, the user must close his/her lips tight in order to keep cleaning liquid from leaking out of his/her mouth. This holding force direction is in the same direction as the vibrations generated by the ultrasonic vibrating elements. Therefore, ultrasonic vibrations are absorbed by the user's soft tissues of lips and cheeks. The end result totally defeats the purpose of the ultrasonic vibrating elements. There is room for improvement.

### BRIEF SUMMARY OF THE INVENTION

This invention embodies a teeth cleaning apparatus, comprising a mouthpiece, a transducer, a cleaning liquid supply unit and a power and control unit. Said mouthpiece comprises a containment wall, a hollow ingress connector and a vibrator holder. Said containment wall is a U-shaped structure. Said hollow ingress connector provides a passage through said containment wall. Said vibrator holder comprises a vibrator holder hole and a vibrator holder body, wherein said vibrator holder body is located near the center of said U-shaped containment wall and has a hollow body. Said vibrator holder hole is a hole through said vibrator holder body. Said transducer, which generates high frequency vibrations and is synonymous with a vibrator in this invention, comprises a stationary part and a vibratory part, wherein said stationary part is held in said vibrator holder for assembling with said mouthpiece and positioning said vibratory part near and surrounded by said containment wall. Said cleaning liquid supply unit comprises a cleaning liquid container, at least one connecting tube and a cleaning liquid delivery element, wherein said connecting tube is connected to said hollow ingress connector of said mouthpiece and said cleaning liquid delivery element delivers cleaning liquid in said cleaning liquid container through said connecting tube and said hollow ingress connector. Said power and control unit is connected to said transducer to provide electricity for operating said transducer at a frequency to generate cavitation bubbles to clean teeth.

In one embodiment of this invention, said transducer is a piezoelectric transducer.

In said one embodiment of this invention, said stationary part comprises a stationary end and a hollow bolt, and said transducer comprises a transducer body, a first lid, a first piezoelectric disc, a second lid and a second piezoelectric disc wherein said transducer body has a void space and said first piezoelectric disc and said second piezoelectric disc are positioned in said void space of said transducer body.

In said one embodiment of this invention, ultrasonic vibrations from said first piezoelectric disc and said second piezoelectric can pass through said first lid and said second lid, respectively, to agitate said cleaning liquid surrounding said transducer so as to generate cavitation bubbles that propagate upward and downward concurrently from the external surfaces of said first lid and said second lid, to reach the inner and outer surfaces of all upper teeth and lower teeth in similar distances.

In another embodiment of this invention, said containment wall has short flanges along its edges.

In another embodiment of this invention, said transducer is an electro-mechanical vibrator.

In another embodiment of this invention, said transducer is a mechanical vibrator.

In another embodiment of this invention, said cleaning liquid delivery element is a pump.

In another embodiment of this invention, said cleaning liquid delivery element is a gravity driven element.

This invention describes a teeth cleaning method using a teeth cleaning apparatus as said first embodiment of this invention in cleaning a user's teeth, comprising:

Partially inserting said mouthpiece in a user's mouth, positioning said vibratory part of said transducer in the user's work cavity and the bottom area of said containment wall of said mouthpiece below the user's mouth opening so as to keep said cleaning liquid inside the user's work cavity;

Using said cleaning liquid supply unit to deliver said cleaning liquid supply into the user's work cavity until a cleaning liquid level higher than all teeth of the user;

And then, turning on said power and control unit to operate said transducer to vibrate and thus generate cavitation bubbles to clean all teeth of the user submerged in said cleaning liquid in the user's work cavity below said cleaning liquid level.

Referring to an embodiment described below will explain the purpose, technical merit and effectiveness of this invention.

### BRIEF DESCRIPTION OF THE DRAWINGS

FIG. 1 is an exploded view of a teeth cleaner unit.

FIG. 2A shows an assembled mouthpiece and a transducer in one view.

FIG. 2B shows an assembled mouthpiece and a transducer in a second view.

FIG. 2C shows an assembled mouthpiece and a transducer in a third view.

FIG. 2D shows an assembled mouthpiece and a transducer in a fourth view.

FIG. 3 shows the overall use of the teeth cleaning apparatus.

FIG. 4A shows the cleaner unit in a user's work cavity.

FIG. 4B is the section view 4B-4B of FIG. 4A.

FIG. 5A shows the teeth cleaning apparatus in a user's work cavity in another view.

FIG. 5B is the section view 5B-5B of FIG. 5A.

FIG. 6 is an exploded view of a transducer.

FIG. 7 shows the method sequences of this invention.

### DETAILED DESCRIPTION

The inventor has spent multiple years in researching issues with teeth cleaning with ultrasonic devices to improve shortcomes of existing technologies. Descriptions below explains how this invention improves the effectiveness of a teeth cleaning apparatus.

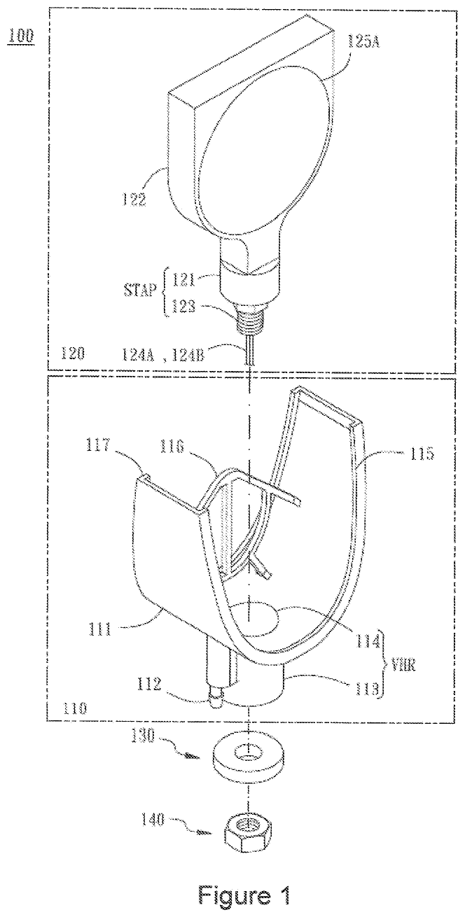

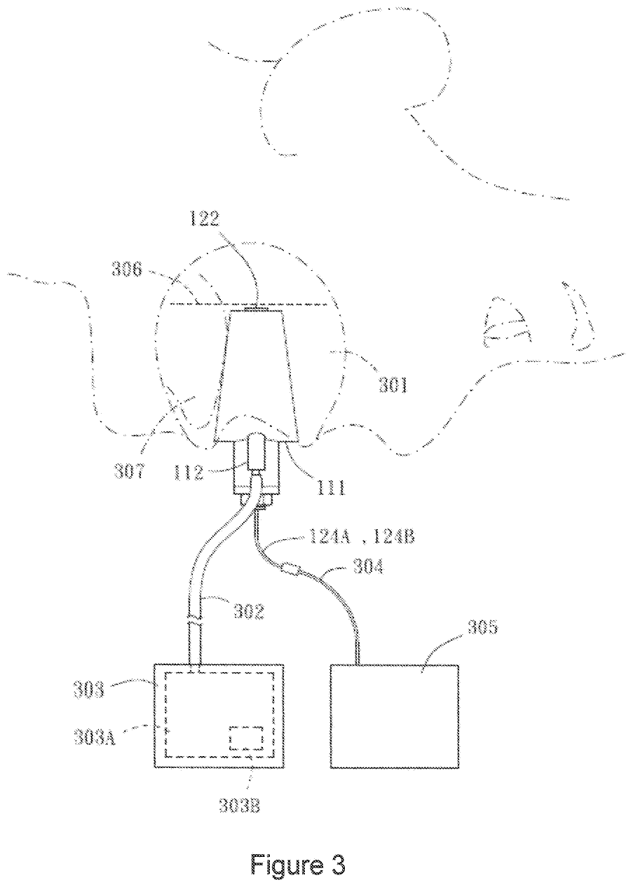

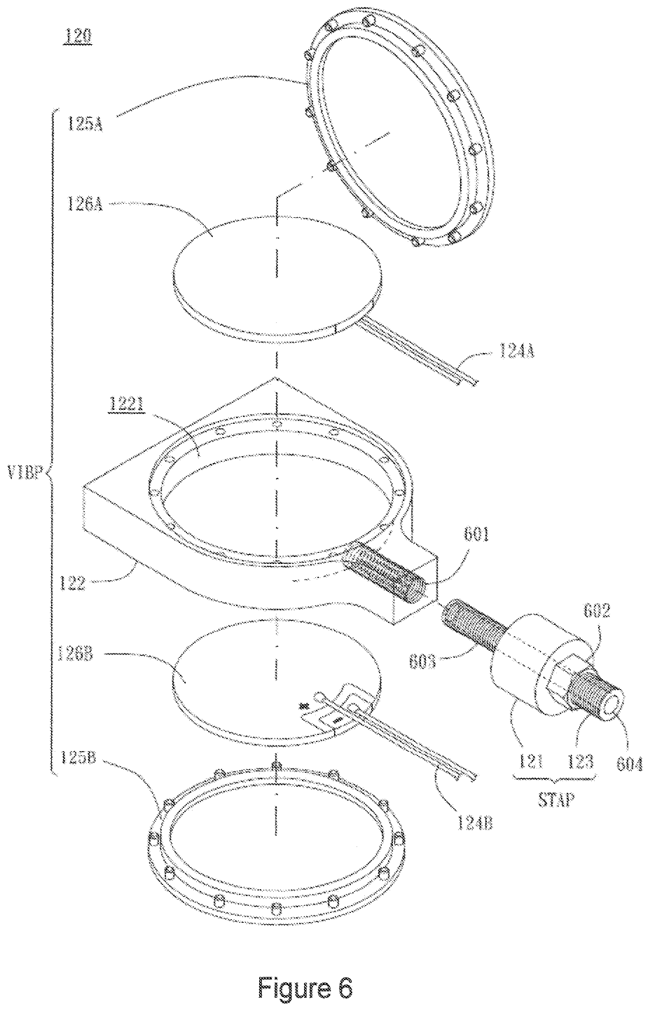

Refer to FIG. 1 and FIG. 6. FIG. 1 is an exploded view of Teeth Cleaner Unit 100. FIG. 6 is an exploded view of Transducer 120 used in FIG. 1. To avoid cluttering, hidden lines are not shown. Not yet connected to Cleaning Liquid Supply Unit 303 and Power And Control Unit 305 that will be shown in FIG. 3, Teeth Cleaner Unit 100 comprises Mouthpiece 110, Transducer 120, Washer 130 and Nut 140. Washer 130 and Nut 140 need no further explanations. Mouthpiece 110 and Transducer 120 are explained in the next 3 paragraphs below. An exploded view of Transducer 120 is detailed in FIG. 6.

To use Teeth Cleaning Unit 100 in a user's work cavity, Teeth Cleaning Unit 100, including Mouthpiece 110 and Transducer 120, is connected to Cleaning Liquid Supply Unit 303 and Power And Control Unit 305 shown in FIG. 3. Mouthpiece 110 comprises Containment Wall 111, Hollow Ingress Tube Connector 112 and Vibrator Holder VHR. Containment Wall 111 is a U-shaped structure and has short flanges along its edges, including Upper Flange 115 and Lower Flange 117. Hollow Ingress Tube Connector 112 has a hole to provide passage through Containment Wall 111. Vibrator Holder VHR comprises Vibrator Holder Hole 114 and Vibrator Holder Body 113 and is located around the center area of U-shaped Containment Wall 111 wherein Vibrator Holder Body 113 is a hollow body and Holder Hole 114 is the hollow part of Vibrator Holder Body 113 with openings at both ends. Transducer 120 comprises Stationary Part STAP and Vibratory Part VIBP, wherein Stationary Part STAP includes Stationary End 121 and Hollow Bolt 123 while Vibratory Part VIBP includes Transducer Body 122, First Lid 125A, First Piezoelectric Disc 126A, Second Lid 125B and Second Piezoelectric Disc 126B. Transducer Body 122 has a Void Space 1221. First Piezoelectric Disc 126A has a pair of positive and negative electrical connection points, Second Piezoelectric Disc 126B also has a pair of positive and negative electrical connection points. It is worth mentioning Stationary Part STAP of Transducer 120 is kept in Vibrator Holder VHR through tightening of Nut 140 over Washer 130 on Hollow Bolt 123 and that Vibratory Part VIBP is surrounded by and disposed near U-shaped Containment Wall 111 in this assembled condition. Furthermore in FIG. 3, Cleaning Liquid Supply Unit 303 comprises Cleaning Liquid Container 303A, at least one Connecting Tube 302 and Cleaning Liquid Delivery Element 303B. Connecting Tube 302 is connected to Hollow Ingress Tube Connector 112. Cleaning Liquid Delivery Element 303B can deliver cleaning liquid from Cleaning Liquid Container 303A through Connecting Tube 302 and Hollow Ingress Tube Connector 112 to the other side of Mouthpiece 110. Power And Control Unit 305 is electrically connected to Transducer 120, providing power to operate Transducer 120 at a frequency to generate cavitation bubbles for cleaning teeth. FIG. 6 further details composition of Transducer 120. Transducer 120 can be, but not limited to, a piezoelectric transducer, an electro-mechanical vibrator or a mechanical vibrator.

Mouthpiece 110 is an injection molded component with many functional areas including U-shaped Containment Wall 111, Hollow Ingress Tube Connector 112, Vibrator Holder VHR (including Vibrator Holder Body 113 with Vibrator Holder Hole 114 inside), Upper Range 115 along one edge of Containment Wall 111, Tongue Guard 116 and Lower Flange 117 along the other edge of Containment Wall 111, Hollow Ingress Tube Connector 112 is located on the outside of Containment Wall 111 and has a passage through Containment Wall 111. Tongue Guard 116 is surrounded by U-shaped Containment Wall 111.

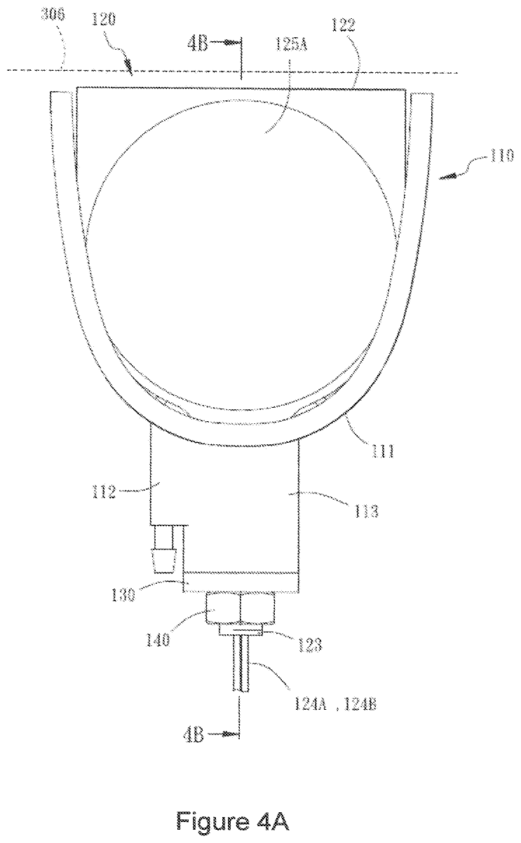

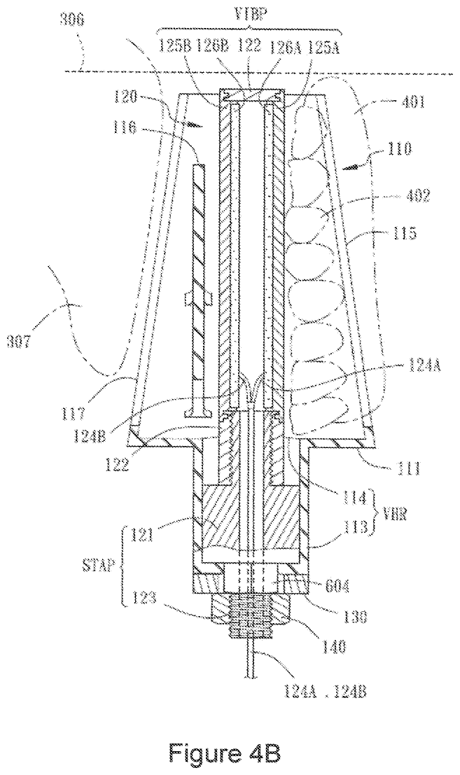

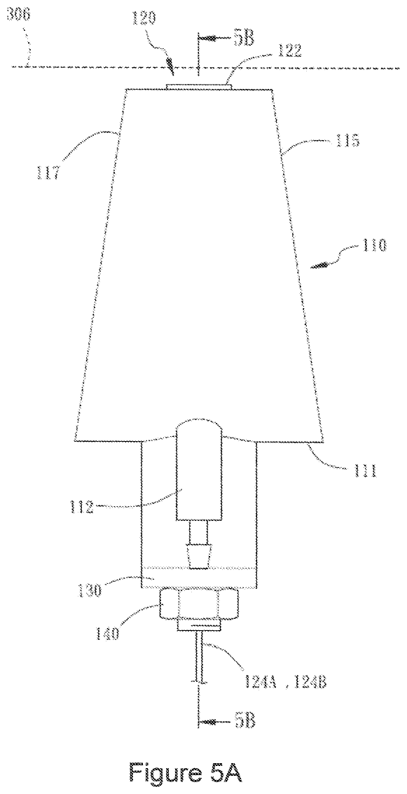

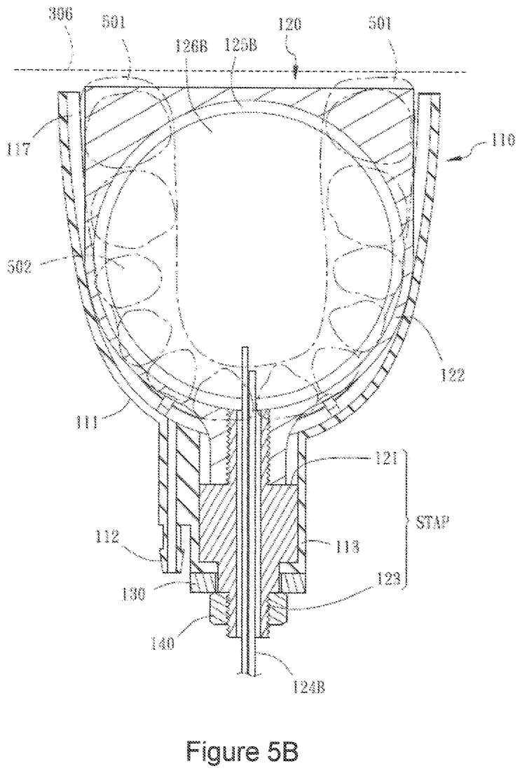

As a component of Teeth Cleaner Unit 100, Transducer 120 is described below about its functional areas. Refer to FIG. 6, Transducer 120 comprises Stationary End 121, Hollow Bolt 123, Transducer Body 122, a pair of First Wires 124A, a pair of Second Wires 124B, First Lid 125A, Second Lid 125B, First Piezoelectric Disc 126A and Second Piezoelectric Disc 126B, First Piezoelectric Disc 126A and Second Piezoelectric Disc 126B will be described further in FIGS. 4A through 5B. First Wires 124A run through Hollow Bolt 123 and Stationary End 121 to provide electricity to First Piezoelectric Disc 126A which is affixed to the inside surface of First Lid 125A which in turn is fixed to Void Space 1221 inside Transducer Body 122. First Wires 124A are soldered to the positive and negative electrical connection points of First Piezoelectric Disc 126A. In the same token, Second Wires 124B run through Hollow Bolt 123 and Stationary End 121 to provide electricity to Second Piezoelectric Disc 126B which is affixed to the inside surface of Second Lid 125B which in turn is fixed to Void Space 1221 inside Transducer Body 122. Second Wires 124B are soldered to the positive and negative electrical connection points of Second Piezoelectric Disc 126B, FIG. 6 will further describe the assembly sequences of Transducer 120 and show positional relationships between First Piezoelectric Disc 126A and First Lid 125A as well as between Second Piezoelectric Disc 126B and Second Lid 125B.

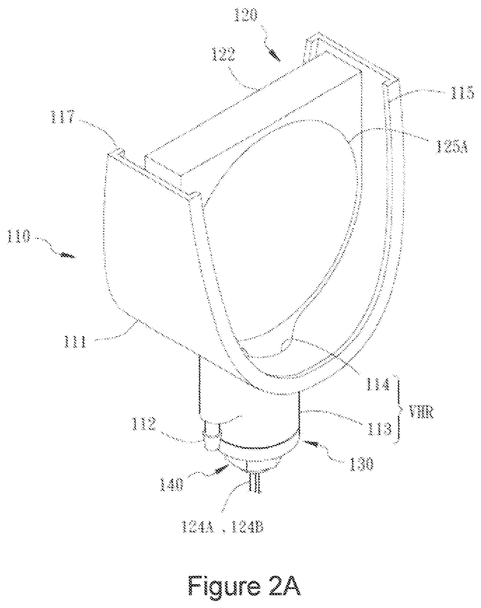

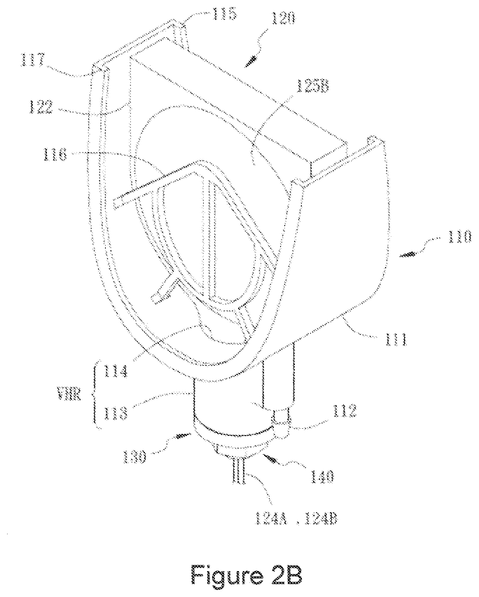

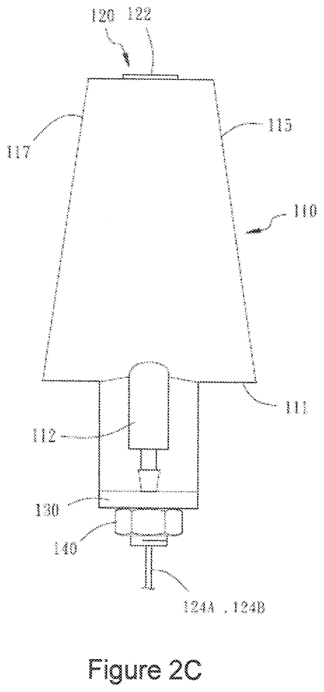

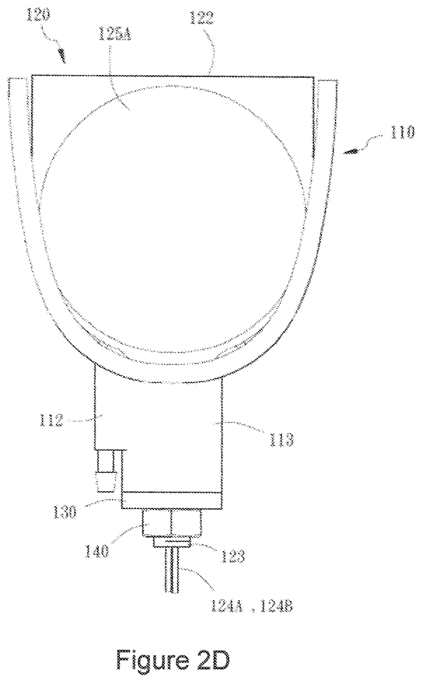

To assemble Teeth Cleaner Unit 100, Stationary End 121 of Transducer 120 is first inserted into Vibrator Holder Hole 114 of Containment Wall 111, with First Wires 124A, Second Wires 124B and Hollow Bolt 123 extended below Vibrator Holder Body 113. Washer 130 and Nut 140 are then applied to Hollow Bolt 123 through Vibrator Holder Hole 114 to secure Transducer 120 tightly against the bottom of Holder Body 113 which has a smaller diameter than Stationary End 121. The resulting Teeth Cleaner Unit 100 is shown in 4 different views in FIGS. 2A, 2B, 2C and 2D to help visualize Teeth Cleaner Unit 100.

Refer to FIG. 2A, FIG. 2B, FIG. 2C and FIG. 2D, 4 different views of Teeth Cleaner Unit 100. To avoid cluttering, hidden lines are not shown. FIG. 2A is the isometric view in the same orientation as in FIG. 1, looking at the front-right-top corner. FIG. 2B is another isometric view looking at the front-left-top corner. FIG. 2D is an orthogonal view looking from the right. FIG. 2C is an orthogonal view 90 degrees from FIG. 2D looking from the front. These views provide better visualization of all functional areas of both Mouthpiece 110 and Transducer 120.

Refer to FIG. 3, an overall use of the teeth cleaning apparatus in relation to the user's mouth and head. Physical components of the present invention are drawn in solid lines while supporting articles are drawn in phantom lines. Components previously identified in FIG. 1 retain their identification numbers in FIG. 3. The silhouette of a user's head drawn in phantom lines shows he/she is in a face-down posture. The viewing direction is the same as in FIG. 2C.

Containment Wall 111 of Mouthpiece 110 is partially inserted into a user's mouth between his/her outer gums surfaces and internal surfaces of his/her lips and cheeks, forming Work Cavity 301 surrounding his/her teeth (not drawn to avoid cluttering) and Transducer 120 (of which only the top of Transducer Body 122 is drawn.) Upper Flange 115 and Lower Flange 117 (both not drawn and will be explained in FIG. 4A, FIG. 4B, FIG. 5A and FIG. 5B) are in contact with the user's outer gums surfaces to ensure adequate room, for accommodating cleaning liquid exists between his/her teeth surfaces and U-shaped Containment Wall 111 of Teeth Cleaner Unit 100. Said room is not visible in FIG. 3 and will be illustrated in FIG. 4A, FIG. 4B, FIG. 5A and FIG. 5B.

Connecting Tube 302 connects Hollow Ingress Tube Connector 112 of Mouthpiece 110 to Cleaning Liquid Supply Unit 303 and serves as a conduit for delivering cleaning liquid from Cleaning Liquid Supply Unit 303 into Work Cavity 301. Cleaning Liquid Supply Unit 303 comprises Cleaning Liquid Container 303A, Connecting Tube 302 and Cleaning Liquid Delivery Element 303B that can be turned on and off to deliver cleaning liquid into Work Cavity 301 via Connecting Tube 302 and Ingress Tube Connector 112. In embodiments of the present invention, Cleaning Liquid Delivery Element 303B can be a pump driven element or a gravity driven element. Cleaning Liquid Delivery Element 303B can also be installed inside Cleaning Liquid Container 303A.

Electric Wires 304 are connected to Power And Control Unit 305 to deliver electric power via First Wires 124A and Second Wires 124E to Transducer 110 which is inside Work Cavity 301 and only the top portion of Transducer Body 122 is drawn in FIG. 3. Power And Control Unit 305 includes a power source and an ultrasonic control circuit that can be turned on and off to operate Transducer 120.

The user turns on Cleaning Liquid Delivery Element 303B (which is a pump in one embodiment of this invention) of Cleaning Liquid Supply Unit 303 to fill cleaning liquid in Work Cavity 301 up to liquid level 306 so as to partially submerge tongue 307 and totally submerge all of his/her teeth, which will be illustrated in FIG. 4A, FIG. 43, FIG. 5A and FIG. 53. Then, the user turns on Power And Control Unit 305 to start operating Transducer 120 to clean the teeth. Turning off Power And Control Unit 305 terminates the cleaning process. Then, Teeth Cleaner Unit 100 is removed from the mouth to discharge cleaning liquid.

Refer to FIG. 4A and FIG. 4B, showing details of an assembled teeth cleaner unit in a user's work cavity. FIG. 4B is the section view 4B-4B in FIG. 4A for showing the user's tongue and teeth in relationship with Teeth Cleaner Unit 100. FIG. 4A is the same view as in FIG. 2D with an additional section plane 4B-4B the section view is shown in FIG. 4B. Physical components of the present invention are drawn in solid lines while supporting articles are drawn in phantom lines. The user's upper teeth 402 and upper gum 401 are drawn in section view 4B-4B in FIG. 4B, while lower teeth 502 and lower gum 501 are not drawn to avoid cluttering. Components previously identified in FIG. 1 and FIG. 3 retain their identification numbers in FIG. 4A and FIG. 4B.

First Piezoelectric Disc 126A and Second Piezoelectric Disc 126B are affixed to the inside surfaces of First Lid 125A and Second Lid 1253, respectively, with high strength epoxy so as to ensure ultrasonic vibrations generated by First Piezoelectric Disc 126A and Second Piezoelectric Disc 126B can be passed to the external surfaces of First Lid 125A and SecondLid 125B, respectively. First Lid 125A and Second Lid 125B are fixed to the internal surfaces of Transducer Body 122 in Void Space 1221. Ultrasonic vibrations of First Piezoelectric Disc 126A and Second Piezoelectric Disc 126E can generate cavitation bubbles on external surfaces of First Lid 125A and SecondLid 125B, Tongue Guard 116 keeps tongue 307 from touching Second Lid 125B held in Transducer Body 122. Upper Flange 115 is in contact with the user's upper gum 401. Upper teeth 402 are totally submerged in cleaning liquid below liquid level 306. Upper teeth 402 are also located close to First Lid 125A, Lower Flange 117 is in contact with the user's lower gum which is not drawn to avoid cluttering, Lower teeth 502, also not drawn to avoid cluttering, are totally submerged in cleaning liquid below liquid level 306. Lower teeth 502 are also located close to the external surface of Second Lid 125B held in Transducer Body 122. Cavitation bubbles generated by ultrasonic vibrations of First Piezoelectric Disc 126A and Second Piezoelectric Disc 126E at the external surfaces of First Lid 125A and Second Lid 125B can propagate over similar distances to reach both inside and outside surfaces of all upper teeth 402 and all lower teeth 502 and achieve similar cleaning efficacy.

Refer to FIG. 5A and FIG. 5B, showing details of an assembled teeth cleaner unit in a user's work cavity in a second section view. FIG. 5A is the same viewing direction as in FIG. 2C with an additional section plane 5B-B. FIG. 5B is a section view at section plane 58-5B. Physical components of the present invention are drawn in solid lines while supporting articles are drawn in phantom lines. The user's lower gum 501 and lower right teeth 502 are drawn in section view 5B-5B in FIG. 58, while the user's lower left teeth 502 are not drawn to avoid cluttering. Components previously identified in FIG. 1 and FIG. 3 retain their identification numbers in FIG. 5A and FIG. 5B.

In FIG. 5B, First Piezoelectric Disc 126A and Second Piezoelectric Disc 126B are shown positioned inside of Transducer Body 122 in section view 5B-5B. Transducer Body 122 is located closer to the viewer than lower gum 501 and lower teeth 502. Lower Flange 117 is in contact with lower gum 501. All lower teeth 502 are totally submerged below liquid level 306 and have similar distances from the external surface of Transducer Body 122. Cavitation bubbles generated by ultrasonic vibrations of First Piezoelectric Disc 126A and Second Piezoelectric Disc 126B at the external surfaces of First Lid 125A and Second Lid 1258 can propagate over similar distances to reach both inside and outside surfaces of all upper teeth 402 and all lower teeth 502 and achieve similar cleaning efficacy.

Refer to FIG. 6, an exploded view of Transducer 120 for its assembly procedure. Components previously identified in FIG. 1 retain their identification numbers in FIG. 6. Stationary End 121 consists of functional areas Hollow Bolt 123, Locker Nut 602, Locker Bolt 603 and Center Hole 604 which runs through Hollow Bolt 123, Locker Nut 602, Stationary End 121 and Locker Bolt 603. First, solder First Wires 124A to the positive and negative electrical connection points, respectively, of First Piezoelectric Disc 126A. Also, solder Second Wires 124B to the positive and negative electrical connection points, respectively, of Second Piezoelectric Disc 1268. Next, run First Wires 124A and Second Wires 1248 through Threaded Hole 601 at the end of Transducer Body 122. Next, coat the bottom surfaces of First Piezoelectric Disc 126A and Second Piezoelectric Disc 126B, respectively, with high strength epoxy to affix First Piezoelectric Disc 126A and Second Piezoelectric Disc 126B to the internal surfaces of First Lid 125A and Second Lid 1258, respectively. Next, apply water-proofing material around the rims of First Lid 125A, Second Lid 125B and Transducer Body 122 and inside Threaded Hole 601. Next; press-fit First Lid 125A and Second Lid 1258; respectively, into the rims of Transducer Body 122 so as to seal First Piezoelectric Disc 126A and Second Piezoelectric Disc 126B in Void Space 1221 inside Transducer Body 122. Next, run First Wires 124A and Second Wires 1248 through Center Hole 604. Next, apply flexible water-proofing material over surfaces of Threaded Hole 601 and Locker Bolt 603. Next, apply flexible water-proofing material or insert a flexible water-proofing O-ring between the square area around Threaded Hole 601 and its mating area on Stationary End 121. Finally, turn Locker Nut 602 to tighten Locker Bolt 603 into Threaded Hole 601 to complete assembly of Transducer 120. When assembling Transducer 120 onto Mouthpiece 110, Washer 130 and Hex Nut 140 are applied to Hollow Bolt 123. The force holding Transducer 120 onto Mouthpiece 110 is along the center-line of Center Hole 604.

When power is applied, First Piezoelectric Disc 126A and Second Piezoelectric Disc 126B affixed to the inside surface of First Lid 125A and Second Lid 125B, respectively, (which in turn are fixed to Transducer Body 122) vibrate along the axle directions of First Piezoelectric Disc 126A and Second Piezoelectric Disc 126B. The vibration direction is perpendicular to the center line of Center Hole 604, or, the direction of force holding together Transducer Body 122 and Stationary End 121. Therefore, the force holding Transducer 120 onto Mouthpiece 110 does not impede the vibrations of First Piezoelectric Disc 126A and Second Piezoelectric Disc 126B and the ultrasonic cleaning efficacy is greatly improved upon prior arts.

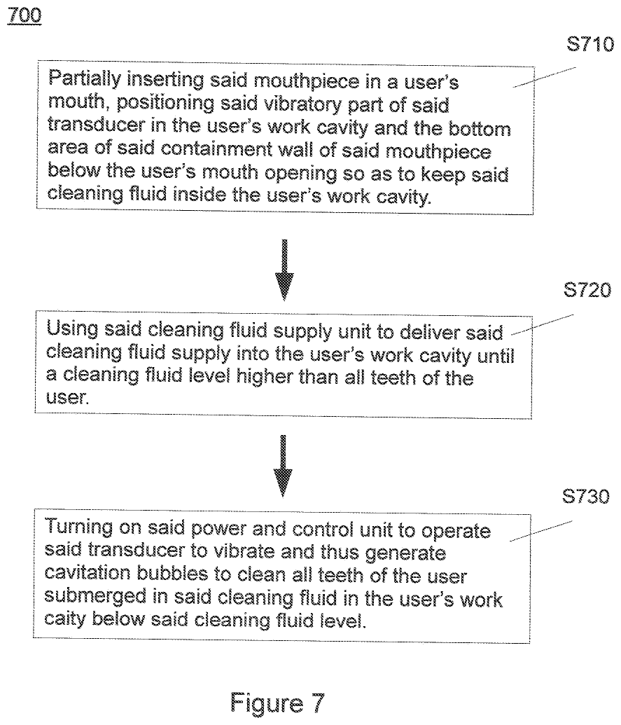

In addition, the above described embodiment of this invention reveals a new method for using Teeth Cleaning Unit 100 in a face-down posture when cleaning teeth. Refer to FIG. 7 for Method Sequences 700 of this new method:

Step S710 Partially inserting said mouthpiece in a user's mouth, positioning said vibratory part of said transducer in the user's work cavity and the bottom area of said containment wall of said mouthpiece below the user's mouth opening so as to keep said cleaning fluid inside the user's work cavity;

Step S720 Using said cleaning fluid supply unit to deliver said cleaning fluid supply into the user's work cavity until a cleaning fluid level higher than all teeth of the user;

Step S730 Turning on said power and control unit to operate said transducer to vibrate and thus generate cavitation bubbles to clean all teeth of the user submerged in said cleaning fluid in the user's work cavity below said cleaning fluid level.

What has been described in detail above are sample embodiments of the present invention and shall not be interpreted as limitations of this invention.

### LIST OF LABELS

100: Teeth Cleaner Unit
110: Mouthpiece
111: Containment Wall
112: Hollow Ingress Tube Connector
VHR: Vibrator Holder
113: Vibrator Holder Body
114: Vibrator Holder Hole
115: Upper Flange
116: Tongue Guard
117: Lower Flange
120: Transducer
121: Stationary End
122: Transducer Body
1221: Void Space
STAP: Stationary Part
123: Hollow Bolt
124A: First Wires
125A: First Lid
126A: First Piezoelectric Disc
1124B: Second Wires
125B: Second Lid
126B: Second Piezoelectric Disc
VIBP: Vibratory Part
130: Washer
140: Nut
301: Work Cavity
302: Connecting Tube
303: Cleaning Liquid Supply Unit
303A: Cleaning Liquid Container
303B: Cleaning Liquid Delivery Element
304: Electric Wires
305: Power And Control Unit
300: liquid level
307: tongue
401: upper gum
402: upper teeth
501: lower gum
502: lower teeth
601: Threaded Hole
602: Locker Nut
603: Locker Bolt
604: Center Hole
700: Method Sequences
S710: method step
S720: method step
S730: method step

1. A teeth cleaning apparatus comprising:
1.1 a mouthpiece, comprising:
1.1.1. a containment wall having a U-shaped structure;
1.1.2. a hollow ingress connector on said containment wall and having a hole through said containment wall;
1.1.3. a vibrator holder on said containment wall, comprising a vibrator holder hole and a vibrator holder body, wherein said vibrator holder body is a hollow body located near the center of said U-shape of said containment wall and said vibrator holder hole is a hole through said vibrator holder body;
1.2 a transducer, comprising a stationary part and a vibratory part, wherein said stationary part of said transducer is held in said vibrator holder of said mouthpiece and said vibratory part of said transducer is positioned near and surrounded by said containment wall of said mouthpiece;
1.3 a cleaning liquid supply unit, comprising a cleaning liquid container, at least a connecting tube, and a cleaning liquid delivery element, wherein said connecting tube is connected to said hollow ingress connector of said mouthpiece and said cleaning liquid delivery element delivers cleaning liquid in said cleaning liquid container through said connecting tube and said hollow ingress connector; and
1.4 a power and control unit wherein said power and control unit is electrically connected to said transducer to provide electric power for operating said transducer at a frequency to generate cavitation bubbles to clean teeth.

2. The teeth cleaning apparatus of claim 1, wherein said vibratory part comprising a transducer body, a first lid, a first piezoelectric ceramic disc, a second lid, and a second piezoelectric ceramic disc, wherein said transducer body having a void space to accommodate said first lid, said first piezoelectric ceramic disc, said second lid, and said second piezoelectric ceramic disc.

3. The teeth cleaning apparatus of claim 2, wherein ultrasonic vibrations generated by said first piezoelectric ceramic disc and said second piezoelectric ceramic disc pass through said first lid and said second lid, respectively, to agitate cleaning liquid surrounding said transducer and generate cavitation bubbles that propagate upward and downward concurrently from the external surfaces of said first lid and said second lid.

4. The teeth cleaning apparatus of claim 1, wherein said containment wall has short flanges along its edges.

5. The teeth cleaning apparatus of claim 1, wherein a tongue guard is attached to said containment wall.

6. The teeth cleaning apparatus of claim 1, wherein a tongue guard is attached to said transducer.

7. The teeth cleaning apparatus of claim 1, wherein said transducer of said mouthpiece is a piezoelectric transducer.

8. The teeth cleaning apparatus of claim 1, wherein said transducer of said mouthpiece is an electro-mechanical vibrator.

9. The teeth cleaning apparatus of claim 1, wherein said transducer of said mouthpiece is a mechanical vibrator.

10. The teeth cleaning apparatus of claim 1, wherein said cleaning liquid delivery element is a pump driven element.

11. The teeth cleaning apparatus of claim 1, wherein said cleaning liquid delivery element is a gravity driven element.
